(19) United States
(12) Patent Application Publication
(10) Pub. No.: US 2006/0228265 A1
(43) Pub. Date: Oct. 12, 2006

(54) Particulate separation filters and methods

(76) Inventors: Sean X. Peng, Ambler, PA (US); David M. Ritchie, Princeton, NJ (US); Stephen J. Juzwin, Somerset, NJ (US); Martin Cousineau, Clinton, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/399,807

(22) Filed: Apr. 7, 2006

Related U.S. Application Data
(60) Provisional application No. 60/669,043, filed on Apr. 7, 2005.

(51) Int. Cl. B01L 9/00

(52) U.S. Cl. 422/102

(57) ABSTRACT

The present invention provides a novel fluid separator apparatus adapted for us with a multi-well plate. The separator is preferably adapted to separate fluid from particulate, amorphous or viscous material present in the fluid. The separator may be used in biological, immunological, histological biomarker and genomic detection assays and screening assays as well as for medical and chemical applications.

This patent application claims priority from U.S. Provisional Patent Application No. 60/669,043 filed Apr. 7, 2005 entitled “Particulate Separation Filters and Methods”.

### FIELD OF THE INVENTION

The present invention relates to filters useful for separating particulate from liquid. In particular, the present invention relates to filters useful for the processing of biological fluids.

### BACKGROUND

High-throughput bioanalysis and automated liquid handling has contributed significantly to the progress of the pharmaceutical industry. However, the transfer of biological samples from their collection tubes to other tubes or multiwell plates during sample preparation and extraction often represents the slowest stage in the process. As an example there are often complications associated with the manipulation of biological samples such as, blood by-products, including plasma and serum. These substances are often frozen and stored prior to analysis or testing. The freeze/thaw process introduces clots, such as thrombin clots, that plug or otherwise clog pipettes and automated liquid-transfer systems. Since the development of high through-put technology, automated liquid handling, multi-channnel pipettes and robotic work stations have made sample transfer more efficient, but these techniques are limited by the presence of thrombin clots or other viscous or particulate matter in the plasma samples. Depending on the species, storage temperature, and number of freeze and thaw cycles, these clots can cause pipette failure that may approach 100%. (Berna M, Murphy A T, Wilken B, Ackermann B. Collection, storage, and filtration of in vivo study samples using 96-well filter plates to facilitate automated sample preparation and LC/MS/MS analysis. Anal Chem. 2002 Mar. 1;74(5):1197-201.)

When tips become clogged, in any analytical or quantitative assay, multiple transfer attempts are required to transfer sufficiently sized aliquots of the sample aliquots during assay set up. Multiple transfers to obtain a sufficient sample size reduces the overall efficiency and accuracy of the assay and usually requires manual intervention and substantial operator time, particularly when robotic systems are used. Material costs increase when additional tips and pipettes are required because of pipette failure. The use of anti-coagulants such as EDTA, sodium citrate, and heparin have been utilized to reduce the formation of thrombin clots whenever possible; however the presence of clots in even a small percentage of the study samples remains problematic. Additionally, in studies where serum is required, the use of anti-coagulants is unacceptable and the problem of dealing with the clot and clogged or plugged tips and pipettes remains.

Furthermore, high-throughput technology, multi-channel pipettes and robotic work stations are used in conjunction with the isolation of nucleic acids from samples of lysed cells derived from: bacterial cell cultures, mammalian cell cultures, insect cell cultures, plant cultures, yeast cell cultures and others. While multi-channel pipettes and robotic workstations have made sample transfer more efficient for cell culture sample manipulation. Cell lysate-lipid debris and excessively viscous samples can substantially reduce the efficiency of pipettes and other liquid-extracting machinery. The sample type, storage temperature, buffer solutions, and cell number all impact whether a cell sample can clog or plug pipette tips. Again, additional materials, such as tips and pipettes are required when clots cause pipette failure, thereby increasing study cost

Sample transfer is also required for a variety of other diagnostic and research applications. Further, those of ordinary skill in the art can also recognize that there are a myriad of applications where viscous material as well as large and medium size particulate complicates sample manipulation for a variety of liquid-based assays and tests. The art teaches a number of methods to separate out unwanted debris from samples in preparation for diagnostic and research assays. These methods generally include some kind of centrifugation or filtration step requiring that each individual sample be separately manipulated (i.e., transferred individually to a vessel suited to centrifugation or filtration). Such methods substantially add to the time and cost of an assay.

The present invention provides a method to quickly and easily remove viscous matter and particulate from samples, particularly samples containing biologic material, in the preparation for a variety of diagnostic, drug screening or other biological, chemical or medical assays.

### SUMMARY OF THE INVENTION

The present invention relates to a multi-well fluid separator device, comprising a face plate, the face plate comprising a plurality of openings along a substantially flat surface, the openings permitting access to a plurality of filtration cylinders, the filtration cylinders having an open end and a closed end and pores positioned along the surfaces of the cylinder, sized to separate particulate contained in a liquid sample. In a preferred embodiment, the apparatus preferably comprises an alignment marking. The alignment marking can comprise a post, groove, printed marking or notch.

The present invention also relates to a method of filtering a liquid sample, comprising the steps of placing a liquid sample in a multi-well plate; positioning a multi-well fluid separator, comprising a face plate, the face plate comprising a plurality of openings along a substantially flat surface, the openings permitting access to a plurality of filtration cylinders, the filtration cylinders having an open end and a closed end and pores positioned along the surfaces of the cylinder, sized to separate particulate contained in a liquid sample over a multi-well plate. The method further comprises lowering the filtration cylinders into the wells of the multi-well plate and allowing fluid from the multi-well plate to move into the filtration cylinder; and removing fluid from said cylinder.

In one embodiment, the inserting step further comprises the step of aligning at least one well of the filter over a well of the multi-well plate using at least one alignment marker. Preferred alignment markers include notches, printed marking, grooves, plate shapes or at least one guide post.

In a method of the present invention, at least a portion of the biological sample is excluded by a cylinder of the separator. In one example, the sample is a biological, medical or chemical sample. The sample can include a biological fluid and this biological fluid can be a cell lysate or cell fraction obtained from a cell or tissue sample. Fluids that benefit from the separator of this invention include sputum, whole blood, a fraction of whole blood, plasma, serum, blood cells, amniotic fluid, spinal fluid, semen, bone marrow, tissue, fine-needle biopsy samples, urine, peritoneal fluid, or pleural fluid. Other fluids include those generally containing DNA or protein or any fluid containing amorphous or viscous particulate

Other aspects, features and advantages of the invention will be apparent from the following disclosure, including the detailed description of the invention and its preferred embodiments and the appended claims.

### BRIEF DESCRIPTION OF THE FIGURES

FIG. 1 is a perspective view of a preferred embodiment of this invention illustrating a multi-well fluid separator 100 positioned to integrally associate with a multi-well plate 300.

FIG. 2 is a side view of the embodiment of FIG. 1 illustrating the integral association of the multi-well fluid separator 100 with the multi-well plate 300 when properly aligned to facilitate the extraction of filtered fluids from wells 4.

### DETAILED DESCRIPTION

All publications cited herein are hereby incorporated by reference. Unless defined otherwise, all technical and scientific terms used herein have the same meaning as commonly understood to one of ordinary skill in the art to which this invention pertains.

As used herein, the terms “comprising”, “containing”. “having” and “including” are used in their open, non-limiting sense.

The following are abbreviations that are at times used in this specification:

cDNA=complementary DNA

ELISA=enzyme-linked immunoabsorbent assay

PAGE=polyacrylamide gel electrophoresis

PCR=polymerase chain reaction

RT-PCR=Reverse transcription polymerase chain reaction

SDS=sodium dodecyl sulfate

Definitions:

A “biological sample” as used herein refers to a sample comprising matter derived from or containing cells, tissues or fluids from a subject. The “subject” can be bacteria, yeast, plants, insects or mammals, including rodents, animals and humans. Examples of biological samples from a mammal include, for example, sputum, whole blood or any fraction thereof such as plasma or serum, blood cells (e.g., white blood cells), amniotic fluid, semen, bone marrow, spinal fluid, tissue, fine-needle biopsy samples, urine, peritoneal fluid, pleural fluid, and cell cultures. Biological samples may comprise any bacterial species. “Nucleic acid” refers to the arrangement of either deoxyribonucleotide or ribonucleotide residues in a polymer in either single- or double-stranded form. Nucleic acid sequences can be composed of natural nucleotides of the following bases: thymidine, adenine, cytosine, guanine, and uracil; abbreviated T, A, C, G, and U, respectively, and/or synthetic analogs. Synthetic analogs may include nucleotide and nucleoside analogs as well as non-nucleotide and non-nucleoside analogs.

In using the device of the present invention, many conventional techniques in molecular biology, microbiology and assay design are used. These techniques are generally well-known and are explained in, for example, Current Protocols in Molecular Biology. Vols. I, II, and III, F. M. Ausubel, ed. (1997); Maniatis, Fritsch, Sambrook, Molecular Cloning: A Laboratory Manual, Cold Spring Harbor Laboratory Press, Cold Spring Harbor, N.Y. (2001); Snyder and Champness, Molecular Genetics of Bacteria, American Society for Microbiology, Washington D.C. (1997); Tortora, Funke and Case, Microbiology an Introduction, Benjamin/Cummings Publishing, Redwood City, Calif. (1992); and Glick and Pasternak, Molecular Biotechnology, Principles and Applications of Recombinant DNA, American Society for Microbiology, Washington D.C. (1994).

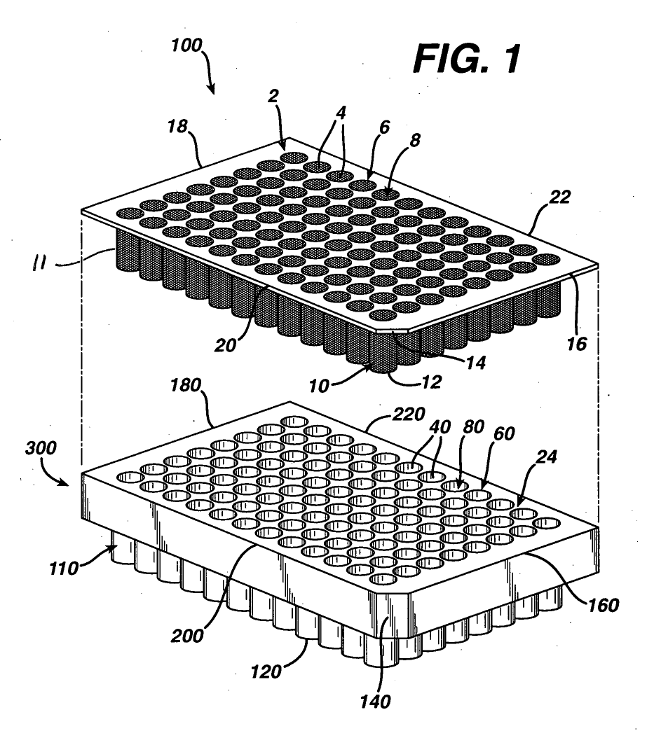

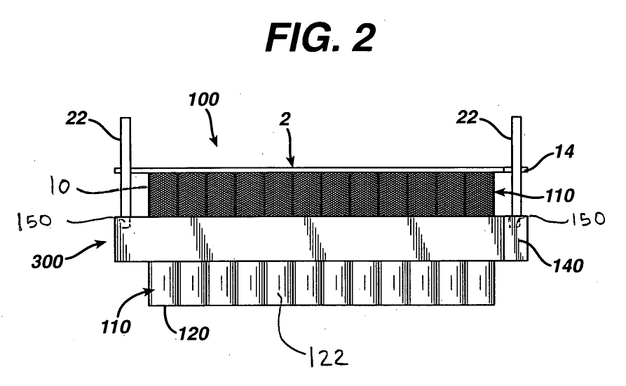

The present invention relates to a multi-well fluid separation device adapted to integrally align and fit within a plurality of wells, such as would be found in a multi-well tissue culture or microtiter plate. Multi-well tissue culture plates and microtiter plates are well known in the biological, medical and chemical arts. These plates are available from a variety of suppliers, such as NUNC, Fischer Scientific, and the like. The plates generally come in a variety of sizes, but the most common multi-well plates are generally that of the standard 96-well plate. Additionally the number of wells can vary in a multi-well plate and plates with 4, 6, 12, 48, 96 and 120 wells or more are made for a variety of assay and research applications. It is further contemplated that the multi-well plates used in this invention can be custom made and coordinated with the multi-well fluid separators of this invention. In addition, while a substantially rectangular shaped multi-well fluid separator and multi-well plate are illustrated in FIGS. 1 and 2, other configurations including, but not limited to circular, triangular and square shaped multi-well plates and multi-well fluid separators are also within the scope of the present invention.

Referring now to FIG. 1, a perspective view of one embodiment of the presently disclosed invention. In this example a multi-well fluid separator 100 comprises a face plate 2, with a plurality of wells 4, each well has an opening rim 6 associated with face plate 2 and a filtration cylinder 10 affixed to face plate 2 along opening rim 6. The filtration cylinder 10 preferably mirrors the contours of a single well 110 of a multi-well plate 300. In the embodiment provided in FIG. 1, the filtration cylinder 10 includes cylinder sides 11 and bottom 12 to form separator chamber 8 such that the multi-well fluid separator 100 comprises a plurality of separator chambers 8. The face plate 2 of the separator 100 also preferably comprises a separator alignment marking 14 designed to orient the face plate 2 with the multi-well plate 300 thereby allowing the user to keep track of the different samples contained in the wells of multi-well plate 300. Where the separator 100 is substantially rectangular, the face plate 2 of the separator 100 further comprises two sets of opposing and parallel edges 16 and 18 and conversely, edges 20 and 22 respectively. Although it will be understood that while the separator 100 is preferably configured to conform to a multi-well plate, other configurations are possible including, as noted above, face plates generally in the shape of a square, circle or alternatively any configuration covering at least a portion of a multi-well plate irrespective of the multi-well plate's configuration.

A multi-well plate 300, as exemplified in FIG. 1, and generally known in the art comprises a face plane 24, with a plurality of openings 40, each opening associated with a single well 110, the single well 110 further comprising an opening rim 60 affixing well 110 to face plane 24. The well 110 preferably includes a bottom 120 and side surfaces 122. The face plate 24 of the multi-well plate 300 preferably includes a multi-well alignment marking 140 designed to aid the user in orienting the samples contained within the multi-well plate 300 and to align with the separator alignment marking 14 of face plate 2. The face plate 24 of the multi-well plate 300 further comprises two sets of generally opposing and parallel edges 160 and 180 and conversely edges 200 and 220, that, in this embodiment, are generally perpendicular to parallel edges 160 and 180. In a preferred embodiment, face plate 2 conforms, at least approximately to the shape and size of face plane 24.

FIG. 2 is side view of the embodiment provided in FIG. 1. Here, separator 100 is shown partially inserted into multi-well plate 300. Also shown is the face plate 2 of the separator 100 and a plurality of filtration cylinders 10, each of which is affixed to face plate 2 at opening rim 6, as shown in FIG. 1. In this diagram, the separator 100 optionally comprises at least one guide post 22 to additionally act as alignment guides. In this embodiment, guide post 22 inserts into a guide hole 150, positioned on face plane 24 of multi-well plate 300 to assist the user in aligning the plurality of cylinders of the separator over the wells 110 of the multi-well plate. As depicted in FIG. 1, the multi-well plate 300, comprises a plurality of wells 110, each having a bottom 120. The multi-well plate 300, also preferably, but not necessarily, comprises a multi-well alignment marking 140 designed to aid the user in orienting the samples contained within the multi-well plate 300.

The filtration cylinder 10 of the multi-well fluid separator 100 is illustrated in FIGS. 1 and 2 to fit fairly snugly and follow the contours of the individual wells of the multi-well plate 300. Those of ordinary skill in the art will readily appreciate that the filtration cylinder need only be as large and of such dimension as to permit the controlled egress of fluid from the separator chamber 8 via a variety of means, including, most commonly, some kind of pipetting apparatus or device, whether manual or automatic. Similarly, the shape of the filtration cylinder 10 need only be so large as to permit the removal of the desired volume of liquid from the separator apparatus. Thus, the filtration cylinder 10 can take on a variety of shapes and sizes. The filtration cylinder 10 is therefore not required to take the shape of the well of a multi-well plate, as depicted in FIGS. 1 and 2, but could take the shape of a small cube, a cone, or a pyramid.

Similarly, the cylinder bottom 12, which is depicted as a flat, circular plane, can also take on a concave or convex shape or alternatively the filtration cylinder 10 can take on the shape of an inverted cone. Thus, cylinder bottom 12 could conform to the bottom 120 of well 110 of the multi-well plate 300 or can alternatively take on any shape or size, limited only in the ability of the filtration cylinder 10 to fit within a well 110 such that fluid contained in well 110 fills separator chamber 8 with enough fluid to permit the fluid to be removed and used, preferably in subsequent diagnostic and research applications.

The embodiment of FIGS. 1 and 2 includes separator alignment markings 14 associated with the multi-well fluid separator 100. In general, those skilled in the an will recognize that the clipping of a corner of face plate 2 to form separpator alignment marking 14 or the addition of at least one guide post 22 and guide holes 150 are purely illustrative. There are a variety of other alignment means including, but not limited to notches, colored markings, grooves, as well as face plate 2 and face plane 24 conformations that integrally mesh with one another. In addition, markings, grooves or notches along the edges of the fluid separator 100 and multi-well plate 300 could also serve the alignment function.

The separators of the present invention may be constructed from virtually any suitable material provided that both the material of the face plate and that of the filtration cylinder substantially resist or withstand exposure to the components, fluids or solvents used with the test samples. For example, the filtration cylinder may be constructed from metals such as aluminum, steel, titanium, or amalgams, alloys and composites thereof. Again, depending on the composition of the sample, the fluid separator of the present invention may be constructed from polymeric materials including, but not limited to, polystyrene, poly(phosphoesters), polysulfones, polyfumarates, polyphosphazines, poly(alkylene oxides), poly(arylates), poly(anhydrides), poly(hydroxy acids), polyesters, poly(ortho esters), polycarbonates, poly(propylene fumerates), poly(caprolactones), polyamides, polyamino acids, polyacetals, polylactides, polyglycolides, poly(dioxanones), polyhydroxybutyrate, polyhydroxyvalyrate, poly(vinyl pyrrolidone), biodegradable polycyanoacrylates, biodegradable polyurethanes, polysaccharides, tyrosine-based polymers, poly(pyrrole), poly(aniline), poly(thiophene), polystyrene, non-biodegradable polyurethanes, polyureas, poly(ethylene vinyl acetate), polypropylene, polymethacrylate, polyethylene, poly(ethylene oxide), and mixtures, adducts, co-polymers and composites thereof.

Preferably face plate 2 is prepared from a polycarbonate or from a non-reactive metal. Preferably the filtration chamber is prepared from a material sufficiently porous to permit the transit of fluid from wells of the multi-well plate into the separator changers. Therefore, in a preferred embodiment, the filtration cylinder 10 is prepared from a metal mesh or screen material.

The filtration cylcinders may be constructed by injection molding, punch pressing, punch molding, compression molding, milling, spot welding, arc welding, cold compression welding, bending or any other suitable means desirable.

Additionally the filtration cylinders may be constructed by employing other manufacturing methods such as but not limited to, hot forming processes including, die casting, sand casting, extrusion forging and powder metallurgy. In some embodiments of the present invention cold-forming processes may be employed such as cold rolling, staking, burnishing, and impact extrusion. Further more, sheet metal processes including but not limited to laser cutting, CNC fabrication, bending, stamping including (blanking, drawing, and piercing), and welding may be employed in the manufacture of the present invention.

In some embodiments heat treatments such as annealing, tempering, direct hardening, selective hardening, diffusion hardening and stress relieving may be employed. Additionally, surface treatments such as electroplating, electroless plating, conversion coating, thin-film coating, thermal spraying and high energy treatments may also be used in the manufacture of the biological filter of the present invention.

Machining techniques including but not limited to drilling, reaming, turning, milling, grinding and chip formation may be employed in the production of the present invention.

Rapid Prototyping techniques may be employed in the design of various configurations the present invention such techniques include but are not limited to stereolithography, laser sintering, fused deposition, solid ground curing, ink jet, and rapid tooling.

In some embodiments the pores of the filtration cylinder are produced by drilling such as Computer Numerical Control (CNC) drilling. CNC drilling is commonly implemented for mass production. The drilling machine, however, is often a multi-function machining center that also mills and turns. The largest time sink for CNC drilling is with tool changes, so for speed, variation of hole diameters may be minimized. The fastest machines for drilling varying hole sizes may have multiple spindles in turrets with drills of varying diameters already mounted for drilling. The appropriate drill is brought into position through movement of the turret, so that bits do not need to be removed and replaced. A variety of semi-automated drilling machines are well known in the art. An example is a simple drill press that, on command, drills a hole of a set depth into a part set up beneath it. In order to be cost-effective, the appropriate type of CNC drilling machine may be applied to a particular part geometry. For low-volume jobs, manual or semi-automated drilling may suffice. For hole or pore patterns with large differences in sizes and high volume, a geared head may be more appropriate. If holes are close to each other and high throughput is desired, a gearless head can locate spindles close together so that the hole or pore pattern can be completed in one pass.

As described by Efunda, Inc. (http://www.efunda.com/processes) Efunda, Inc. Sunnyvale, Calif. 94088, the Computer Numerical Control (CNC) fabrication process offers flexible manufacturing runs without high capital expenditure dies and stamping presses.

Tooling may be mounted on a turret which can be as little as 10 sets to as much as 100 sets. This turret can be mounted on the upper part of the press, which can range in capacity from 10 tons to 100 tons in capacity. The turret travels on lead screws, which travel in the X and Y direction and are computer controlled. Alternatively, the workpiece can travel on the lead screws, and move relative to the fixed turret. The tooling is located over the sheet metal, the punch is activated, and performs the operation, and the turret is indexed to the next location of the workpiece. After the first stage of tooling is deployed over the entire workpiece, the second stage is rotated into place and the whole process is repeated. This entire process may then be repeated until all the tooling positions of the turret are deployed.

This method has some advantages, for example the process is very flexible in being able to produce many different configurations of parts due to the modular nature of the tooling employed. In many cases, most of the punches and dies are already available and they can be mixed and matched to produce a variety of configurations. Due to the fact that most of the tooling is “available”; the lead-time for tooling may be reduced or non-existent. All that needs to be done is to schedule the work order in the production shop, after the programming of the CNC process is done. Quantities that can be economically made using this method can be in the thousands depending on the complexity of the part. Simple outer contours and normal size holes will allow the use of this process for many thousands of parts. However, when the part design involves irregular outer contours or large pores requiring a long cycle time, then dedicated tooling may be justified for smaller production runs. Certain parts with tightly spaced pore patterns or slots may require dedicated tooling, however with the CNC turret press, these parts can be easily made using standard tooling.

To maximize utilization of starting material; parts may be nested as close to each other as possible. They can be separated from one another by “micro-ties” which are small width strips that hold the parts together during the punching process. After punching, the parts can be separated by vibrating them in a shaker. The parts are known as “shaker parts” or “shake a part”. This is very cost effective since no special tooling is necessary for separating them.

Burrs may be generated during the stamping process. The burrs are formed on the side of the sheet metal where the punch exits. Properly maintained tools (proper die clearance and sharpening) have burrs that are less than 10% of stock thickness. When designing parts, the burrs may be confined to areas that will not be exposed to handling and should be either folded away or otherwise shielded form the user. Flatness/bowing can be an issue if the hole pattern is tight, and/or where excessive material is punched out. This releases the residual stresses in the material, which causes bowing or twisting of the part. Proper use of clamping and strippers can minimize this, as can subsequent straightening operations. Recognizing which side the bow can occur can also allow some designs to accept this “out of flat” condition by designing features that are not sensitive to this condition. In some situations, curves and other difficult features are produced by punching out small sections at a time. This process is called nibbling. This leads to triangular shaped features. These triangular shaped features give the edge a scalloped look. This scalloping can be pronounced if the nibbling pitch is coarse. The amount of scalloping that can be accepted is a function of tooling and product cost. Clamp marks are cosmetic in nature, and if objectionable, can be so positioned to cut them away in subsequent processing. Lockwashers for threads can be eliminated by forming a dome on the side opposite to the screw head. As the screw is tightened, the domed thread form locks against the male thread and prevents the screw from vibrating loose in service. Parts that need to be welded can be positioned very precisely using shear buttons. Shear buttons on one surface are snugly fitted inside the corresponding holes into the other surface. This allows the parts to be self-jigging and eliminate the need for fixtures and other hold-downs.

As in all part design, the designer should be aware of process strengths, weaknesses. Datums should be through hole centers rather than edges of parts. This is because edges can have tapers or roll-offs, which can skew a datum and subsequent measurement. Sound practice of tolerancing methods such as geometric dimensioning and tolerancing may be appropriate for the dimensioning of these parts.

Feature tolerances can vary from ±0.12 to ±0.38 mm (±0.005 to ±0.015 in). The program can be adjusted to improve these numbers. Repeatability may be 0.05 mm (0.002 in) as long as the machine lead screw advances only in one direction.

Laser cutting machines may also be employed to produce the present invention. They can accurately produce complex exterior contours. The laser beam may be 0.2 mm (0.008 in) diameter at the cutting surface with a power of 1000 to 2000 watts. Laser cutting can be complementary to the CNC/Turret process. The CNC/Turret process can produce internal features such as holes readily whereas the laser cutting process can produce external complex features easily. Laser cutting takes direct input in the form of electronic data from a CAD drawing to produce flat form parts of great complexity. With 3-axis control, the laser cutting process can profile parts after they have been formed on the CNC/Turret process. Lasers work on materials such as carbon steel or stainless steels. Metals such as aluminum and copper alloys may be more difficult to cut due to their ability to reflect the light as well as absorb and conduct heat. This requires more powerful lasers. Lasers cut by melting the material in the beam path. Materials that are heal treatable may harden at the cut edges. This may be beneficial if the hardened edges are functionally desirable in the finished parts. However, if further machining operations such as threading are required, then hardening may need to be limited. A hole cut with a laser may have an entry diameter larger than the exit diameter, creating a slightly tapered hole. The minimum radius for slot corners is 0.75 mm (0.030 in). Unlike blanking, piercing, and forming, (other acceptable methods of hole forming) the normal design rules regarding minimum wall thicknesses, minimum hole size (as a percent of stock thickness) do not apply. The minimum hole sizes are related to stock thickness and can be as low as 20% of the stock thickness, with a minimum of 0.25 mm (0.010 in) for up to 1.9 mm (0.075 in). Contrast this with normal piercing operations with the recommended hole size 1.2 times the stock thickness. Burrs are quite small employing this method compared to blanking and shearing. They can be almost eliminated when 3D lasers are used and further, eliminate the need for secondary deburring operations. As in blanking and piercing, considerable economies can be obtained by nesting parts, and cutting along common lines. In addition, secondary deburring operations can be reduced or eliminated.

In some embodiments, parts of the present invention may be made by stamping. The operations associated with stamping are blanking, piercing, forming, and drawing. These operations can be done with dedicated tooling also known as hard tooling. This type of tooling is used to make high volume parts of one configuration of part design. (By contrast, soft tooling is used in processes such as CNC turret presses, laser profilers and press brakes). All these operations can be done either at a single die station or multiple die stations, performing a progression of operations, known as a progressive die.

Mechanical presses and hydraulic presses are two types of stamping equipment. Mechanical presses have a mechanical flywheel to store the energy, transfer it to the punch and to the work-piece. They range in size from 20 tons up to 6000 tons. Strokes range from 5 to 500 mm (0.2 to 20 in) and speeds from 20 to 1500 strokes per minute. Mechanical presses are well suited for high-speed blanking, shallow drawing and for making precision parts. Hydraulic Presses use hydraulics to deliver a controlled force. Tonnage can vary from 20 tons to 10,000 tons. Strokes can vary from 10 mm to 800 mm (0.4 to 32 in). Hydraulic presses can deliver the full power at any point in the stroke; variable tonnage with overload protection; and adjustable stroke and speed. Hydraulic presses are suitable for deep-drawing, compound die action as in blanking with forming or coining, low speed high tonnage blanking, and force type of forming rather than displacement type of forming.

Optimum clearance (total=per side×2) may be from 20% to 25% of the stock thickness. This can be increased to 30% to increase die life. Punch life can be extended by sharpening the punch whenever the punch edge becomes 0.125 mm in radius or less. Frequent sharpening extends the life of the tool and cuts down on the punch force required. Sharpening is performed by removing only 0.025 mm to 0.05 mm of the material in one pass with a surface grinder. This is repeated until the tool is sharp. If it is done frequently enough, only 0.125 to 0.25 mm of the punch material is removed. Grinding may be done with the proper wheel for the tool steel in question. Information on the proper choice of abrasive material, feeds and speeds, and coolant may be obtained from the abrasive manufacturer. After sharpening the edge may be lightly stoned to remove grinding burrs and end up with a 0.025 to 0.05 mm radius. This can reduce the chance of chipping.

Punching can be done without shear or with shear. Punching without shear is the case where the entire punch surface strikes the material square, and the complete shear is done along the entire cutting edge of the punch at the same time. Punching Force=Punch Perimeter×Stock thickness×Material Shear Strength. For example, if the punch diameter=25 mm, the circumference=78.54 mm, the thickness=1.5 mm, the material shear strength (Steel)=0.345 kN/mm2, then the punching force=78.54×1.5×0.345 (3.09×0.060×25)=or 40.65 kN (i.e. 4.64 tons) or =4.14 Metric Tons (4.64 US Tons).

Punching with shear indicates that the punch surface penetrates the material in the middle, or at the corners, first, and as the punch descends the rest of the cutting edges contact the material and shear the material. The distance between the first contact of the punch with the material, to when the whole punch starts cutting, is the Shear Depth. Since the material is cut gradually (not all at the same time initially), the tonnage requirement is reduced considerably.

The punching force calculated above is multiplied by a shear factor, which ranges in value form 0.5 to 0.9 depending on the material, thickness, and shear depth. For shear depths of 1.5 mm the shear factor ranges from 0.5 (for 1.2 mm/0.047 in stock) to 0.9 (for 6.25 mm/0.25 in stock). For shear depth of 3 mm the shear factor is 0.5. The punching force=punch perimeter×stock thickness×material shear strength×shear factor. Since shear factor is about 0.5, the punching force is reduced by about 50%. For the same example above, punching force=78.54×1.5×0.345 (3.09×0.060×25)×0.5 (Shear Factor) or 40.65 kN (4.64 tons)×0.5 which is equal to 2.07 Metric Tons (2.32 US Tons).

In some embodiments the fluid separator is made from a single material and in a single piece, but in other embodiments the biological filter is constructed from more than one component and/or from more than one material. The individual parts may be attached to each other using adhesives such as glues (for example cyanoacrylates) and/or, heat welding, arc welding, friction fittings, pins, screws, interference fittings or any other suitable means to join the individual parts together.

Welding is the process of permanently joining two or more parts, by melting both materials. The molten materials quickly cool, and the two parts are bonded. Spot welding and seam welding are two very popular methods used for sheet metal parts. Spot welding is primarily used for joining parts that normally up to 3 mm (0.125 in) thickness. Spot-weld diameters may range from 3 mm to 12.5 mm (0.125 to 0.5 in) in diameter.

Low carbon steel is suitable for spot welding. Higher carbon content or alloy steels tend to form hard welds that are brittle and may crack. This tendency can be reduced by tempering. Austenitic Stainless steels in the 300 series can be spot welded as also the Ferritic stainless steels. Martensitic stainless steels may not be desirable since they are very hard. Aluminums can be welded using high power and very clean oxide free surfaces. Plated steel welding takes on the characteristics of the coating. Nickel and chrome plated steels are relatively easy to spot weld, whereas aluminum, tin and zinc may need special preparation inherent to the coating metals.

The thickness of the parts to be welded should be equal or the ratio of thicknesses may be less than 3:1. Weld to weld spacing preferably equals 10 times the Stock thickness. The center of the weld to edge distance is preferably equal to two times the weld diameter at a minimum. The weld to form distance equals the bend radius+1 weld diameter at a minimum. Adequate access for spot welding should be considered. Small flanges in unshaped channels, for example, may restrict the electrode from entering the part. Flat surfaces are easier to spot weld due to easy access. Multiple bends impose access restrictions, and special fixtures may have to be designed to handle the parts, if access is not a problem. Prior to finishing, the spot welds may be sanded or ground to blend the welds with the rest of the surface.

The mating parts can be selfjigged for easy location prior to welding. This can be done by lancing one part and locating in a corresponding slot in the other pan or by boss type extrusion.

Bending is a process by which metal can be deformed by plastically deforming the material and changing its shape. The material is stressed beyond the yield strength but below the ultimate tensile strength. The surface area of the material does not change much. Bending usually refers to deformation about one axis.

Bending is a flexible process by which many different shapes can be produced. Standard die sets are used to produce a wide variety of shapes. The material is placed on the die, and positioned in place with stops and/or gages. The material is held in place with hold-downs. The upper pan of the press, the ram, including the appropriately shaped punch descends and forms the desired bend.

Bending may be done using press brakes. Press brakes normally have a capacity of 20 to 200 tons to accommodate stock from 1 m to 4.5 m. Larger and smaller presses are used for specialized applications. Programmable back gages, and multiple die sets are commercially available.

Air bending is done with the punch touching the workpiece and the workpiece, does not bottom in the lower cavity. As the punch is released, the workpiece ends up with less bend than that on the punch (greater included angle). This is called spring-back. The amount of spring-back depends on the material, thickness, grain and temper. The spring-back usually ranges from 5 to 10 degrees. Usually the same angle is used in both the punch and the die to minimize setup time. The inner radius of the bend is the same as the radius on the punch.

Bottoming, also know as coining, is the bending process where the punch and the workpiece bottom on the die. This makes for a controlled angle with very little spring back. The tonnage required on this type of press is more than in air bending. The inner radius of the workpiece should be a minimum of 1 material thickness in the case of bottoming and up to 0.75 material thickness, in the case of coining. As described by Efunda, Inc. (http://www.efunda.com/processes) Efunda, Inc. Sunnyvale, Calif. 94088.

Thus the face plate of the present invention can be prepared from the same or different material as the filtration cylinder. Where the face plate and filtration cylinders are prepared from different material or made from the same material but as two different portions of the separator device, these two portions can be produced and then affixed to one another using one or more of the aforementioned techniques.

The device of the present invention can be sold together with one or more multi-well plates or provided separately. The devices may be provided sterile, in suitable packaging, made in a disposable form or in a form that may be suitable for repeated use. Where sterility is desired, the separator can be supplied alone or supplied in combination with the multi-well plate. The separator to be prepared from a readily sterilizable material, such that it can be cleaned, sterilized and reused by the end user. Additionally, the separator without or without the multi-well plate may be provided in forms that are free of DNase, RNase, antibodies, pyrogens, or free of other contaminants. In situations where sterilization is not desirable or needed, the user may handle the separator according to their own standard laboratory protocols.

Methods of collecting biological samples from living subjects are well known in the art. These samples often contain substances that must be removed before the material of interest may be assayed. The present invention is directed to provide a solution to this need. The separators of the present invention are particularly suited for the separation of liquid from liquid samples containing amorphous particulate, particulate and viscous matter. Therefore they are useful in a variety of applications including medical sampling, assays involving biological fluids, gross or physical separation techniques to separate precipitate from solvent, serum sampling, specialty chemical manufacture, food sampling, testing and the like.

In some embodiments the separator may be used as a step in the preparation of biological samples, such as in the collection of blood related samples including plasma and serum, in conjunction with automated liquid-transfer systems, multichannel pipettes, robotic work stations and other high through-put technology as discussed earlier. The separator device functions in some embodiments to easily and quickly exclude clots or viscous clumps. For example, thrombin clots formed from patient samples plated in multi-well plates can be effectively pushed aside by the present invention such that pipette sampling becomes easier and more accurate. Additionally, in some embodiments the separator can rapidly and simply separate cell lysate-lipid debris from bacterial cell cultures, mammalian cell cultures, insect cell cultures, yeast cell cultures and others as for example during the isolation of nucleic acids or protein. In some embodiments the user manually inserts the biological filter into the multi-well plate. In other embodiments the biological filter includes a guide plate, stripper plate, guide walls or guide posts to assist the user in aligning the cylinders of the biological filter over wells of the multi-well plate. The guide plate or stripper plate is movable in some embodiments and may slide axially along the cylinders of the biological filter to straighten them. In some embodiments, the biological filter is compatible with automated liquid-transfer systems, multi-channel pipettes, robotic work stations and other high through-put technology and may be inserted with the aid of a robotic arm or other automated system. In another embodiment the bottoms of the cylinders of the biological filter are tapered, conical, or rounded to assist the user in aligning the cylinders of the biological filter over wells of the multi-well plate. In other embodiments where high through-put technology, automated liquid handling, multi-channel pipettes and robotic work stations are not suitable or not desired and manual pipettes or single channel automated are required or desirable, the biological filter of the present may also be used.

After loading the biological samples into the multi-well plate, the biological filter is inserted into the multi-well plate by any means, for example manual insertion or robotic arm insertion. Substances which would normally clog or plug a pipette, for example, thrombin clots and cell lysate-lipid debris are excluded by the biological filter so that the pipette or other fluid extractor inserted into the separator chamber can freely load liquid into a pipette tip or other liquid transferring or holding device.

The sample sizes used with this invention may be of any given volume from about 0.001 milliliters to about 100 milliliters or more. The only practical limit to the volume of the sample is the configuration and size of the multi-well plate or other sample container selected for the application. Those of ordinary skill in the art will be able to adapt the device of this invention to the appropriately sized fluid receptacle or multi-well plate.

### EXAMPLE 1

### Manufacture of the 96-Well Filter Plate

In one embodiment the 96-well filter plate is prepared such that it has a stainless steel face plate, 96 mesh screen filtration cylinders, and a guide plate also known as a stripper plate. The face plate was made from a Number 16 gauge 316 stainless steel sheet with 96 round holes by CNC drilling. All holes were then spot faced and taper drilled. The face plate was finished by end-milling the sheet to the size of 3 inches by 5 inches. The filtration cylinders were made from a shear sintered stainless steel mesh cloth of 18×18 meshes per square inch with 0.009 inches of wire diameter. The mesh blank was rolled to form a cylinder and resistant welded over a mandrel. The cylinder cap obtained from the mesh blank by a punch and die technique was resistant welded on to one opening end of the cylinder. The flange was made on the other opening of the cylinder. The mesh cylinders were then inserted in the machined face plate with flanges softly soldered on the plate spot-face. The face plate surface was polished flat, a mandrel was used to form, center, and enlarge all round openings of the cylinders. A guide plate, also known as a stripper plate, was made from an oversized 1/16″ thick Lexan clear sheet with 96 holes CNC drilled. The guide plate or stripper plate was used to orient and straighten all 96 screen filtration cylinders, thereby aligning the cylinders of the separator over wells of the multi-well plate. All holes were demurred on both sides. The guide plate, or stripper plate, was finalized by endmilling and chamfering the sheet blank to the size of 3 inches by 5 inches.

### EXAMPLE 2

In one embodiment a 96-well fluid separator was invented to prevent pipette plugging caused by various types of clots during plasma sample transfer or processing in the 96-well plate. Traditionally, the clots in plasma samples have to be picked out one-by-one manually before using pipettes for plasma sample transfer, otherwise many pipetting attempts have to be made for a successful transfer. It is time-consuming and labor-intensive. The 96-well screen filter plate consists of a stainless steel sheet with 96 openings and 96 closed-bottom metal screen cylinders attached to the 96 openings (see figures). The metal wire diameter (200-300 um) and screen mesh size or opening (1.2-1.8 mm) were optimized to allow maximum flow of plasma solution from outside to inside of the screen cylinder while preventing the clots from flowing into the inside of the screen. The cylinders of the screen plate were inserted into the 96-well sample plate to filter the plasma solution so that the clots stay outside of the screen cylinder while the clear plasma solution flowed into inside the screen cylinder. In this way, single- and multiple-channel pipettes (manual or robotic) were utilized for plasma sample transfer and processing without concern that pipette tips would become blocked by the clots. The advantages of this 96-well screen plate include (1) simple and easy to use; (2) re-usable and thus cost-effective; (3) usable for both manual and robotic sample preparation; and (4) no need for additional storage space as compared to the use of a filter plate for plasma storage such those provided by (Berna M, Murphy et al, supra).

We claim:

1. A multi-well fluid separator, comprising a face plate, the face plate comprising a plurality of openings along a substantially flat surface, the openings permitting access to a plurality of filtration cylinders the filtration cylinders having an open end and a closed end and pores positioned along the surfaces of the cylinder, sized to separate particulate contained in a liquid sample.

2. The apparatus of claim 1, wherein said face plate further comprises an alignment marking.

3. The apparatus of claim 2, wherein said face plate is rectangular.

4. The apparatus of claim 2, wherein the marker comprises a post or notch.

5. The apparatus of claim 1 in combination with a multi-well plate.

6. A method of filtering a liquid sample, comprising the steps of:
a. placing a liquid sample in a multi-well plate;
b. positioning a multi-well fluid separator, comprising a face plate, the face plate comprising a plurality of openings along a substantially flat surface, the openings permitting access to a plurality of filtration cylinders, the filtration cylinders having an open end and a closed end and pores positioned along the surfaces of the cylinder, sized to separate particulate contained in a liquid sample over a multi-well plate;
c. lowering the filtration cylinders into the wells of the multi-well plate and allowing fluid from the multi-well plate to move into the filtration cylinder; and
d. removing fluid from said cylinder.

7. The method of claim 6, wherein the inserting step further comprises the step of aligning at least one well of the filter over a well of the multiwell plate using at least one alignment marker.

8. The method of claim 6 wherein the alignment marker is a notch, a colored marking, a groove or a guide post.

9. The method of claim 6, wherein at least a portion of the biological sample is excluded by a cylinder of the separator.

10. The method of claim 6, wherein the sample is a biological, medical or chemical sample

11. The method of claim 10 wherein the sample comprises a biological fluid

12. The method of claim 11 wherein the biological fluid is a cell lysate or cell fraction obtained from a cell or tissue sample.

13. The method of claim 11 wherein the fluid is sputum, whole blood, a fraction of whole blood, plasma, serum, blood cells, amniotic fluid, spinal fluid, semen, bone marrow, tissue, fine-needle biopsy samples, urine, peritoneal fluid, or pleural fluid

14. The method of claim 11 wherein the fluid comprises DNA or protein.
